(19) United States
(12) Patent Application Publication
(10) Pub. No.: US 2013/0299443 A1
(43) Pub. Date: Nov. 14, 2013

(54) SPORTS BALL BOTTLE HOLDER

(71) Applicant: Glenn Stewart, North Olmsted, OH (US)

(72) Inventor: Glenn Stewart, North Olmsted, OH (US)

(21) Appl. No.: 13/893,480

(22) Filed: May 14, 2013

Related U.S. Application Data
(60) Provisional application No. 61/646,442, filed on May 14, 2012.

(51) Int. Cl. A61J 9/06

(52) U.S. Cl. CPC A61J 9/06
USPC 215/11.6

(57) ABSTRACT

A sports ball bottle holder for retaining a bottle is disclosed. The sports ball bottle holder includes a skin cover forming the outermost layer of the bottle holder. A foam insert having a central cavity therein and opening at one end to receive the bottle is disposed within the skin cover. A pouch lining is disposed within the central cavity for receiving the bottle. A shoulder bushing is disposed within the opening and extends into the central cavity to receive the bottle.

### CROSS-REFERENCE TO RELATED APPLICATIONS

This application claims the benefit of U.S. Provisional Patent Application No. 61/646,442 filed on May 14, 2012, which is incorporated herein by reference.

### TECHNICAL FIELD OF THE INVENTION

The present invention relates generally to a sports ball bottle holder for retaining a bottle. More specifically, the present invention relates to a sports ball bottle holder including a skin cover, a foam insert having a central cavity therein, and a pouch lining within the central cavity.

### BACKGROUND OF THE INVENTION

Although many healthcare professionals believe that breastfeeding is preferable to bottle-feeding, breastfeeding may not be possible or preferable for all mothers. For these mothers, the alternative requires bottle-feeding their baby stored breast milk or formula. A baby bottle is a bottle with a nipple to drink directly from. It is typically used by infants and young children when a mother does not breastfeed, or if someone cannot (as conveniently) drink from a cup, for feeding oneself or being fed. A baby bottle includes a vessel commonly made of polycarbonate, a teat commonly made of liquid silicone rubber or natural rubber, and a coupling which couples the vessel to the teat in a leak-proof manner. When a child reaches the age when he can grasp an object, he is encouraged to hold his own bottle when he is feeding in a high chair, stroller or car seat.

In today's culture, society has an enormous interest in ball-related sports. In pursuit of these ball sports, it is a common intention to introduce the next generation into the familial culture of the particular chosen ball sport. The novelty of affection for sports will enhance relationships between family members as they follow the development of the infant into his own particular sports interests. The sibling and family rivalry of favoring a particular ball sport may also result in the newborn having multiple selections of sports bottle ball from which to become exposed, which will further enhance the kindred experience.

### SUMMARY OF THE INVENTION

According to an embodiment of the present invention, there is disclosed a sports ball bottle holder for retaining a bottle. The sports ball bottle holder includes a skin cover forming the outermost layer of the bottle holder. A foam insert having a central cavity therein and opening at one end to receive the bottle is disposed within the skin cover. A shoulder bushing is disposed within the opening and extends into the central cavity to receive the bottle.

According to another embodiment of the present invention, there is disclosed a sports ball bottle holder for retaining a bottle. The sports ball bottle holder includes a skin cover forming the outermost layer of the bottle holder. A foam insert having a central cavity therein and opening at one end to receive the bottle is disposed within the skin cover. A pouch lining is disposed within the central cavity for receiving the bottle. A shoulder bushing is disposed within the opening and extends into the central cavity to receive the bottle.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three-dimensional view of a sports ball bottle holder being held by a toddler, in accordance with the present invention.

FIG. 2 is a front, three-dimensional view of a sports ball bottle holder, in accordance with the present invention.

FIG. 3 is a front, three-dimensional view of a sports ball bottle holder complete with the bottle, in accordance with the present invention.

FIG. 4 is an exploded front, three-dimensional view of a sports ball bottle holder, in accordance with the present invention.

FIG. 5 is a cross-sectional view of a sports ball bottle holder, in accordance with the present invention.

FIG. 6 is a front, three-dimensional view of an alternative embodiment of a sports ball bottle holder, in accordance with the present invention.

FIG. 7 is a front, three-dimensional view of an alternative embodiment of a sports ball bottle holder with a bottle, in accordance with the present invention.

FIG. 8 is an exploded front, three-dimensional view of an alternative embodiment of a sports ball bottle holder with a bottle, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

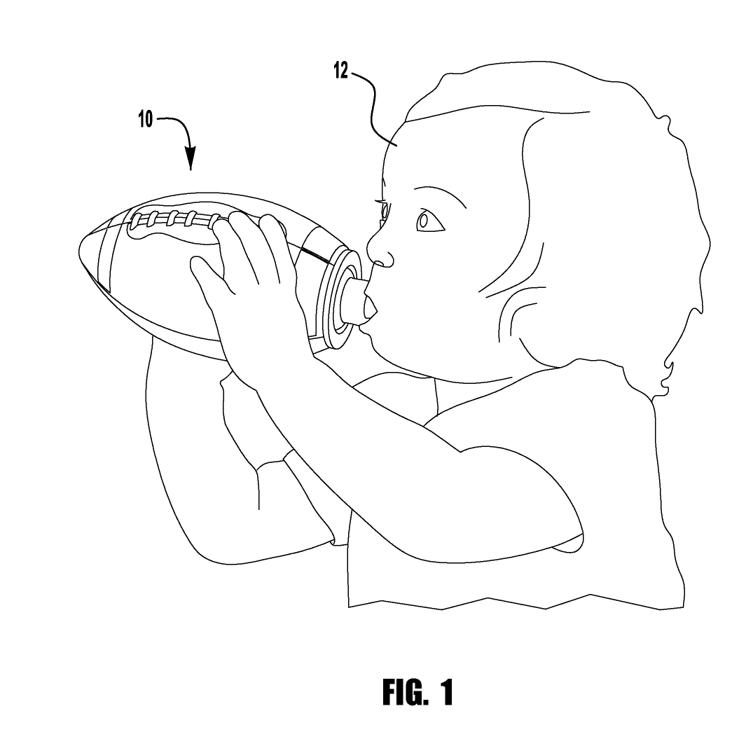

FIG. 1 illustrates a front three-dimensional view of the sports ball bottle holder (hereafter “bottle holder”) 10 being held by a toddler 12 . The bottle holder 10 is a sports ball shaped bottle holder adapted for retaining bottles including but not limited to baby bottles and toddlers cups, with the authentic feel of a ball, such as for example, a football, basketball, baseball, or soccer ball. The principal object of the bottle holder 10 is to provide children, including babies and toddlers, with an advanced development in hand strength, grip, and familiarity with various sports balls. The bottle holder 10 has been designed to progress the development of the child's hands, sports comprehension, and awareness while bottle feeding or drinking from a toddler cup. The bottle holder 10 accomplishes these objects by providing a bottle holder in shape and overall appearance of a sports ball, Moreover, the bottle holder 10 is scaled to fit standard sizes of baby bottles and to be comfortably gripped by the toddler 12.

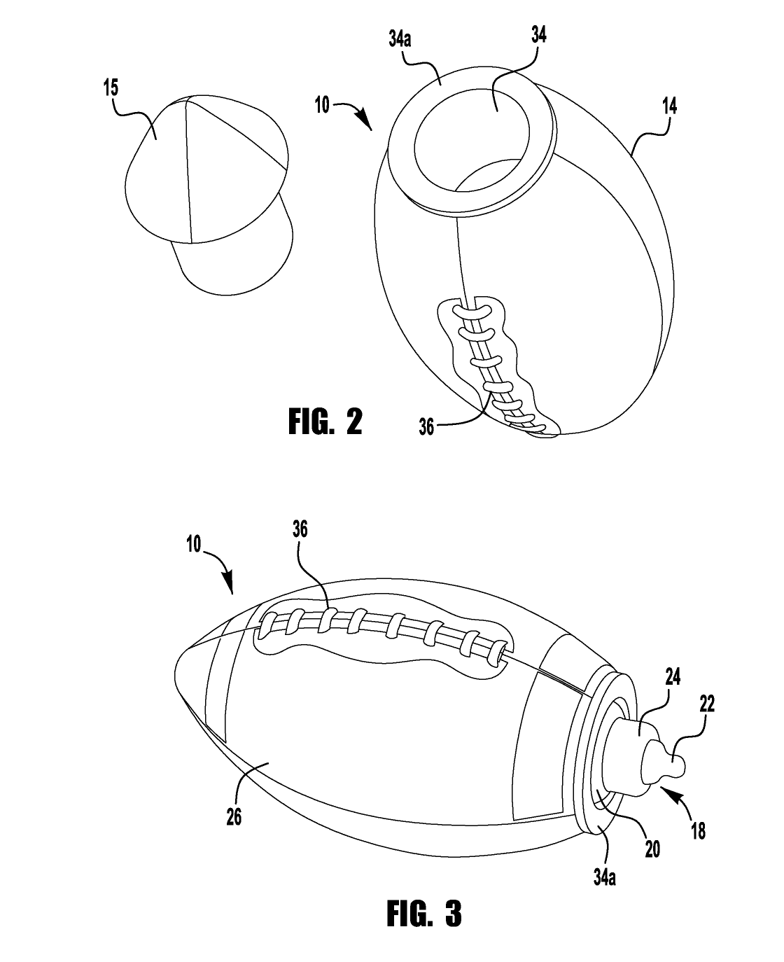

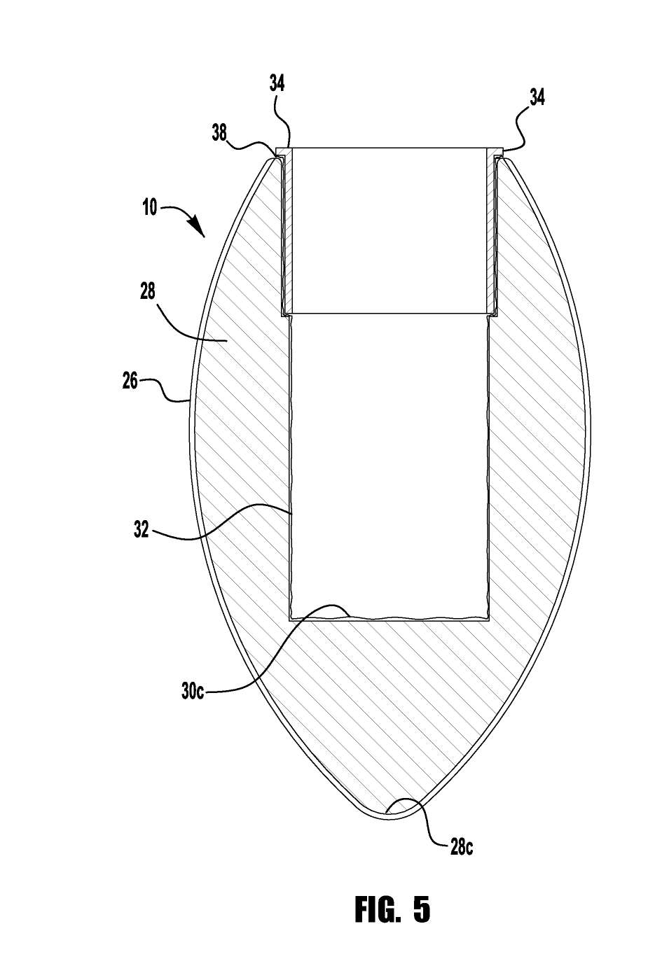

FIG. 2 and FIG. 3 illustrate a front three-dimensional view of the bottle holder 10. The bottle holder 10 may have the appearance of any desired sports ball. A football shaped embodiment 14 has been illustrated in FIG. 2, but any desired sports ball, such as a soccer ball, baseball, softball, cricket ball, golf ball, tennis ball, volleyball, or basketball shaped embodiment 16, as illustrated in FIG. 5 may be utilized. The shape of the bottle holder 10 is not necessary spherical, as with most sports balls, but the shape can be ellipsoidal like that of a football shaped embodiment 14. Furthermore, the bottle holder 10 is in a scaled size appropriate to be manufactured, constructed, or otherwise built so as to receive a range of standard baby bottle 18 sizes. For example, the football shaped embodiment may have a length between about four inches and twelve inches.

The scale of each bottle holder 10 may be increased or decreased in size to accommodate a plurality of popular baby bottle 18 sizes, such as five-ounce or nine-ounce bottles, both of which are two primary standard baby bottle sizes available. The diameter of the bottle older is such that a toddler can comfortably hold the bottle holder, as seen in FIG. 1. Further, bottle holder 10 can accommodate toddler cups (not shown). For example, a golf ball shaped bottle holder 10 would be increased from its normal size to a scale suitable for one of the baby bottle sizes mentioned previously. Similarly, a basketball shaped embodiment 16 is reduced from its normal size to a scale fitting one of the baby bottle sizes mentioned previously. A baby bottle includes a vessel 20 commonly made of polycarbonate, a teat 22 commonly made of liquid silicone rubber or natural rubber, and a coupling 24 which couples the vessel to the teat in a leak-proof manner. It is within the terms of the embodiment that a specifically designed baby bottle 18 accompanies the bottle holder 10 in sale.

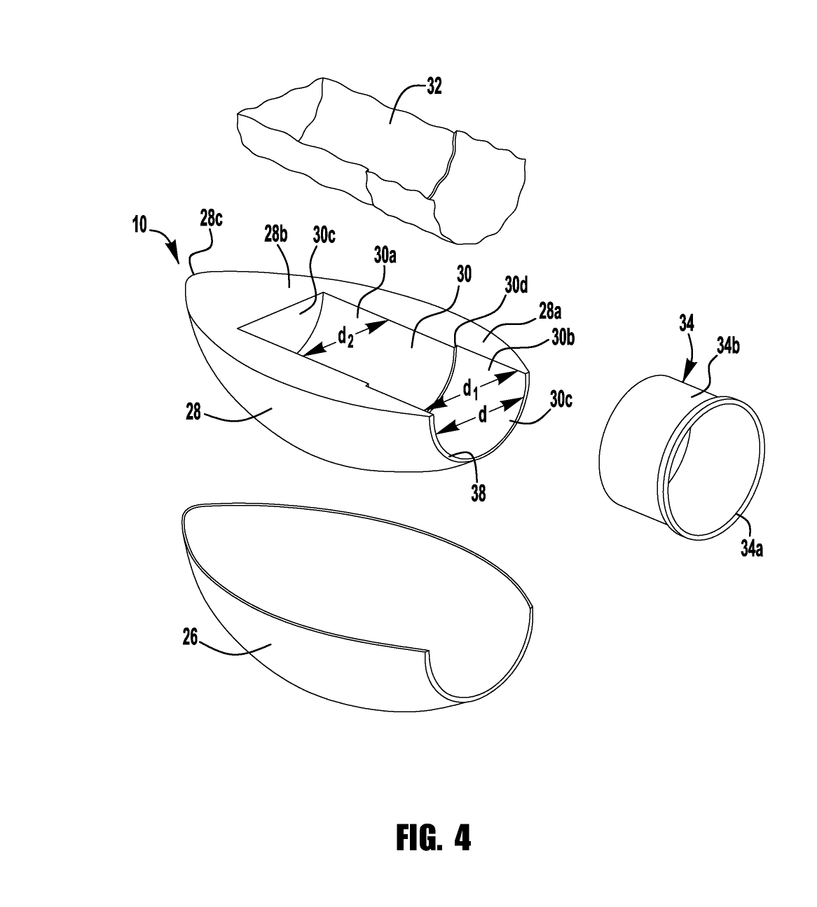

Regardless of the shape and size of the bottle holder 10, the elements that form the bottle holder remain the same. FIG. 4 illustrates an exploded, partial view of the bottle holder 10, including a skin cover 26, an elliptically shaped foam insert 28 with a central cavity 30 therein to secure a baby bottle or toddlers cup, a pouch lining 32, and a plastic shoulder bushing 34. While only half of the bottle holder 10 is illustrated, it is understood that the bottle holder is shaped as shown in FIG. 2.

The skin cover 26 may be constructed of any suitable material, such as synthetic leather, or a plastic polymer. The skin cover 26 of the bottle holder 10 serves as the outermost layer, which reinforces the overall structure of the bottle holder. The skin cover 26 can serve as a decorative layer that includes graphic indicia or textual indicia or a combination thereof. It may have a variety of cosmetic designs or colors that embody the ball design. As seen in FIG. 2 and FIG. 3, the football shaped embodiment 14 of the bottle holder 10 may have a dimpled texture that resemble the dimpling pattern found on a conventional football and synthetic brown leather, complete with white laces 36 to resemble an authentic football.

The skin cover 26 envelopes the elliptically shaped foam insert 28. Elliptically shaped foam insert 28 provides the shape and substance of the bottle holder 10. As seen in FIG. 4, there is a bottom portion 28a and a top portion 28b of the elliptically shaped foam insert 28. The bottom portion 28b has the shape of a traditional football, and comes to a point 28c, to resemble a conventional football. The top portion 28a has a circular opening 38 to receive the bottle 18 to be secured within the bottle holder 10, as seen in FIG. 3. The diameter d of the circular opening 38 may be a range of 1.5 inches to 4.5 inches. The diameter must be large enough to allow standard baby bottle 18 or toddler's cup to fit with the bottle holder 10.

A central cavity 30 is formed within the elliptically shaped foam insert 28 and extends from circular opening 38 to a location approximately halfway down the length of the foam insert to a closed bottom end 30c. The baby bottle 18 is placed and temporarily stored within the central cavity 30 of the foam insert 28 until the entire body of the baby bottle is completely encompassed by the bottle holder 10. The central cavity 30 is of circular shape and may be either uniform diameter through the length of the central cavity, or may have a plurality of differing diameters, as in FIG. 4. As illustrated, there is a first section 30a extending from the bottom end 30c towards the circular opening 38 and a second section 30b of the central cavity 30 which extends between first section 30a and the opening 38. Sections 30a and 30b are separated with a shoulder 30d. Second section 30b has a slightly larger diameter d1 than the diameter d2 of the first section 30a.

A pouch lining 32 lines the interior of the central cavity 30. Pouch lining 32 may be constructed of any suitable material, such as a flexible plastic. Pouch lining 32 is designed to grip the baby bottle 18, such that a variety of disparately sized baby bottles may be accommodated within the bottle holder 10. Further, pouch lining 32 serves to provide a surface that is easy to clean and wash. Should there a spill or leak from the baby bottle 18, pouch lining 32 protects the foam insert 28 of bottle holder 10, which is not designed to absorb liquids.

It is within the terms of the invention that the pouch lining 32 has insulating qualities, such that the liquid within the baby bottle 18 will maintain its temperature longer while inserted in bottle holder 10.

As shown in FIGS. 4 and 5, a plastic shoulder bushing 34 is inserted through opening 38 and secured against the inward facing surface 30c of second section 30b of the central cavity 30. To secure the plastic shoulder bushing 34 within the second section 30b, the bushing may be force fitted, secured thereto with an adhesive such as glue, or any other appropriate method. Plastic shoulder bushing 34 is designed to secure the pouch lining 32 in place by placing an open end of the pouch lining between the outer surface 34b of the bushing and the surface 30e of the second section 30b. Further, plastic shoulder bushing 34 grips the baby bottle 18, and temporarily secures it within the bottle holder 10. There is a lip 34a about the top circumference of the plastic shoulder bushing 34 to hold the bushing in place within the central cavity 30, as seen in FIG. 5.

It is within the terms of the embodiment that there be an insert 15 to be inserted within the central opening 38 so as to close the central opening and form a complete football, so as to resemble a conventional football, as seen in FIG. 2.

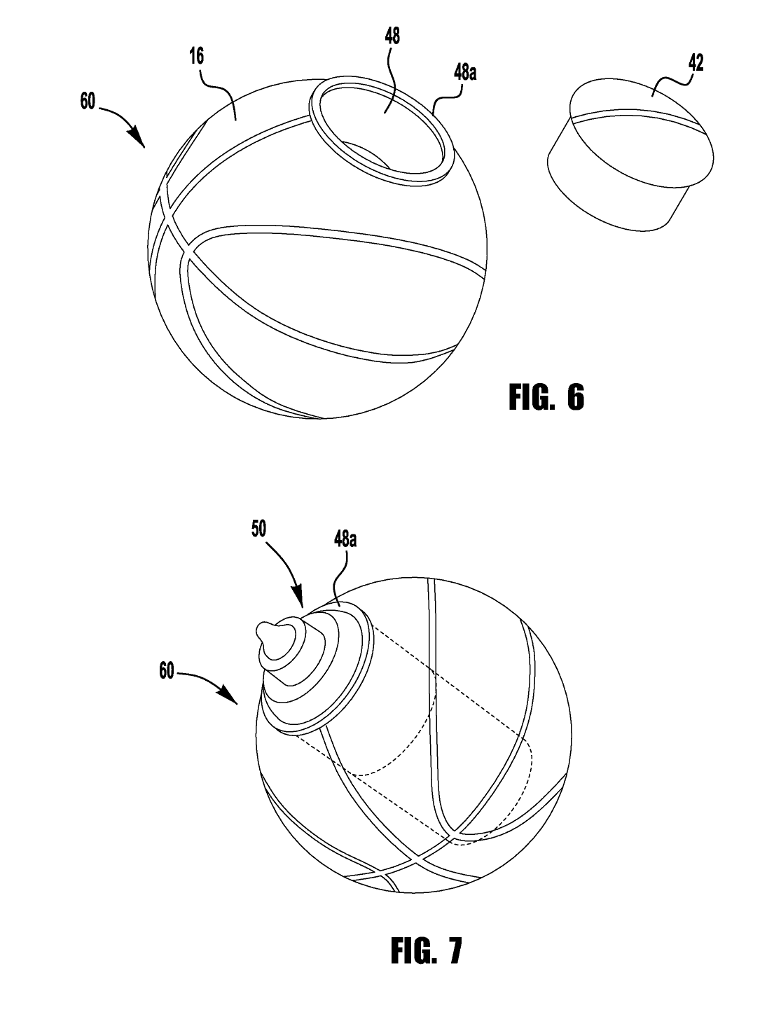

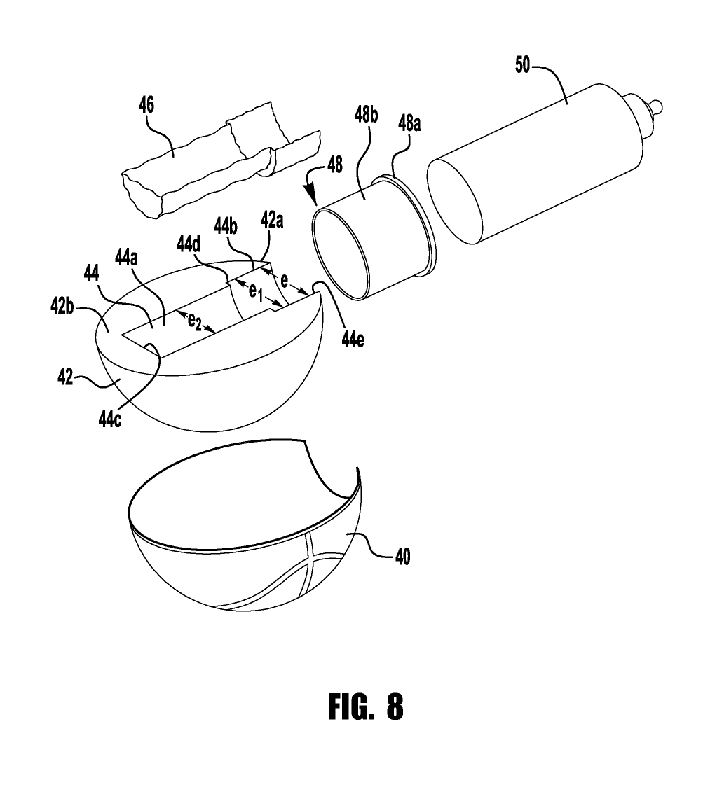

FIG. 6 and FIG. 7 illustrate the basketball shaped embodiment 16 of the bottle holder 60. In this embodiment, bottle holder 60 is spherical in nature. FIG. 8 illustrates an exploded, partial view of the bottle holder 10, including a skin cover 40, an spherically shaped foam insert 42 with a central cavity 44 therein to secure a baby bottle or toddlers cup, a pouch lining 46, and a plastic shoulder bushing 48. A baby bottle 50 is also shown in FIG. 7. While only half of the bottle holder 10 is illustrated, it is understood that the bottle holder is shaped as shown in FIG. 6.

The skin cover 40 may be constructed of any suitable material, such as synthetic leather, or a plastic polymer. The skin cover 40 of the bottle holder 10 serves as the outermost layer, which reinforces the overall structure of the bottle holder. The skin cover 40 can serve as a decorative layer that includes graphic indicia or textual indicia or a combination thereof. It may have a variety of cosmetic designs or colors that embody the ball design. As seen in FIG. 6 and FIG. 7, the basketball shaped embodiment 16 of the bottle holder 60 may have a smooth texture that resembles the pattern found on a conventional football and synthetic orange leather, to resemble an authentic basketball.

The skin cover 40 envelopes the spherically shaped foam insert 42. Spherically shaped foam insert 42 provides the shape and substance of the bottle holder 60. As seen in FIG. 8, there is a bottom portion 42a and a top portion 42b of the spherically shaped foam insert 28. The bottom portion insert 42b has the shape of a traditional basketball, and is circular, to resemble a conventional basketball. The top portion 42a has a circular opening 52 to receive the bottle 50 to be secured within the bottle holder 10, as seen in FIG. 7. The diameter e of the circular opening 38 may be a range of 1.5 inches to 4.5 inches The diameter must be large enough to allow standard baby bottle 50 or toddlers cup to fit with the bottle holder 60.

A central cavity 44 is formed within the spherically shaped foam insert 42 and extends from circular opening 52 to a location approximately halfway down the length of the foam insert to a closed bottom end 44c. The baby bottle 50 is placed and temporarily stored within the central cavity 44 of the foam insert 42 until the entire body of the baby bottle is completely encompassed by the bottle holder 60. The central cavity 44 is of circular shape and may be either uniform diameter through the length of the central cavity, or may have a plurality of differing diameters, as in FIG. 8. As illustrated, there is a first section 44a extending from the bottom portion insert 42b towards the circular opening 52 and a second section 44b of the central cavity 44 which extends between section 44a and the opening 52. Sections 44a and 44b are separated with a shoulder 44d. Second section 44b has a slightly larger diameter e1 than the diameter e2 of the first section 44a.

A pouch lining 46 lines the interior of the central cavity 44. Pouch lining 46 may be constructed of any suitable material, such as a flexible plastic. Pouch lining 46 is designed to grip the baby bottle 50, such that a variety of disparately sized baby bottles may be accommodated within the bottle holder 60. Further, pouch lining 46 serves to provide a surface that is easy to clean and wash. Should there a spill or leak from the baby bottle 50, pouch lining 46 protects the foam insert 42 of bottle holder 60, which is not designed to absorb liquids.

It is within the terms of the invention that the pouch lining 46 has insulating qualities, such that the liquid within the baby bottle 50 will maintain its temperature longer while inserted in bottle holder 60.

As shown in FIG. 7, a plastic shoulder bushing 48 is inserted through opening 52 and secured against the inward facing surface 44c of second section 44b of the central cavity 44. To secure the plastic shoulder bushing 48 within the second section 44b, the bushing may be force fitted, secured thereto with an adhesive such as glue, or any other appropriate method. Plastic shoulder bushing 48 is designed to secure the pouch lining 46 in place by placing an open end of the pouch lining between the outer surface 48b of the bushing and the surface 44e of the second section 44b. Further, plastic shoulder bushing 48 grips the baby bottle 50, and temporarily secures it within the bottle holder 60. There is a lip 48a about the top circumference of the plastic shoulder bushing 48 to hold the bushing in place within the central cavity 44, as seen in FIG. 8.

It is within the terms of the embodiment that there be an insert to be inserted within the central opening attached to the bottle holder 60 adjacent to the second section 44b of the central cavity 44. The function of this insert is to form a complete basketball, so as to resemble a conventional basketball.

It is within the terms of the embodiment that there be an insert 49 to be inserted within the central opening 52 so as to close the central opening and form a complete basketball, so as to resemble a conventional basketball, as seen in FIG. 6.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A sports ball bottle holder for retaining a bottle, comprising:
a skin cover forming the outermost layer of the bottle holder;
a foam insert within the skin cover having a central cavity therein and opening at one end to receive the bottle; and
a shoulder bushing within the opening and extending into the central cavity to receive the bottle.

2. The sports ball bottle holder of claim 1 further including a pouch lining disposed within the central cavity for receiving the bottle.

3. The sports ball bottle holder of claim 1 wherein the skin cover is constructed of a suitable material selected from the group consisting of synthetic leather, plastic and polymer.

4. The sports ball bottle holder of claim 1 wherein:
the shaped foam insert has a bottom portion and a top portion; and
the top portion insert having a circular opening to receive the bottle to be secured within the bottle holder.

5. The sports ball bottle holder of claim 4 wherein the foam insert is elliptically shaped and provides the shape and substance of the bottle holder.

6. The sports ball bottle holder of claim 4 wherein the foam insert is spherically shaped and provides the shape and substance of the bottle holder.

7. The sports ball bottle holder of claim 4 wherein:
the central cavity is formed within the shaped foam insert and extends from circular opening to a location approximately halfway down the length of the foam insert to a closed bottom end.

8. The sports ball bottle holder of claim 7 wherein:
the central cavity is of circular shape and of a uniform diameter through the length of the central cavity.

9. The sports ball bottle holder of claim 7 wherein:
the central cavity is of circular shape and has a plurality of differing diameters.

10. The sports ball bottle holder of claim 7 wherein:
the central cavity has a first section extending from the bottom end towards the circular opening and a second section which extends between the first section and the circular opening.

11. The sports ball bottle holder of claim 10 wherein the first and second sections of the central cavity are separated with a shoulder.

12. The sports ball bottle holder of claim 11 wherein the second section has a larger diameter than the first section.

13. The sports ball bottle holder of claim 10 wherein the plastic shoulder bushing is received through the central opening and secured against an inward facing surface of the second section of the central cavity.

14. The sports ball bottle holder of claim 13 wherein the shoulder bushing is secured within the second section by force fit.

15. The sports ball bottle holder of claim 13 wherein the shoulder bushing is secured within the second section by an adhesive.

16. The sports ball bottle holder of claim 2 wherein the pouch lining is constructed of a flexible plastic which is not designed to absorb liquids and to provide a surface that is easy to clean and wash.

17. The sports ball bottle holder of claim 13 wherein the pouch lining is secured in place by an open end of the pouch lining disposed between an outer surface of the bushing and the inner surface of the second section.

18. The sports ball bottle holder of claim 1 further including an insert to be inserted within the opening so as to close the opening and form a complete ball.

19. A sports ball bottle holder for retaining a bottle, comprising:
a skin cover forming the outermost layer of the bottle holder;
a foam insert within the skin cover having a central cavity therein and opening at one end to receive the bottle;
a pouch lining disposed within the central cavity for receiving the bottle; and
a shoulder bushing within the opening and extending into the central cavity to receive the bottle.

20. The sports ball bottle holder of claim 19 further including an insert to be inserted within the opening so as to close the opening and form a complete ball.
